(19) United States
(12) Patent Application Publication
(10) Pub. No.: US 2006/0177548 A1
(43) Pub. Date: Aug. 10, 2006

(54) Preservative system

(75) Inventors: Bernard Charles Sekula, Glen Gardner, NJ (US); Michael Charles Cirigliano, Cresskill, NJ (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Bestfoods, North America

(21) Appl. No.: 11/053,304

(22) Filed: Feb. 8, 2005

(51) Int. Cl. A21D 4/00

(52) U.S. Cl. 426/321

(57) ABSTRACT

A method for producing a microbiologically stable and safe food composition is described. The method includes the step of contacting a food composition with a saturated, unsaturated, and optionally, an aromatic preservative in order to produce a food composition free of spoilage and pathogens.

### FIELD OF THE INVENTION

The present invention is directed to a preservative system. More particularly, the present invention is directed to a method for preserving a food composition comprising the preservative system. The preservative system is a mixture of saturated, unsaturated, and optionally, aromatic preservatives that, when used, surprisingly result in a microbiologically stable food composition, even in the absence of organic acids. Moreover, the preservative system of this invention surprisingly results in microbiologically safe chilled-food compositions, even at elevated pH values.

### BACKGROUND OF THE INVENTION

Preservatives, like sorbate, benzoate and organic acids have been used in food products. Such preservatives offer a degree of microbiological inhibition. However, conventional preservative systems, in order to be effective, require the presence of organic acids, low pH values, or both in order to achieve microbiological stability across a wide range of food compositions. While high levels of organic acid and/or low pH values can contribute to the stability of edible products, the use of the same almost invariably results in food compositions having inferior taste, olfactory and visual characteristics.

It is of increasing interest to develop a preservative system that may be used across a wide range of food compositions, especially ambient stable and chilled-food compositions. This invention, therefore, is directed to a method for preserving a food composition with a preservative system comprising a mixture of saturated, unsaturated, and optionally, aromatic preservatives. The method of this invention, unexpectedly, results in a microbiologically ambient stable food composition in the absence of organic acids. The method of this invention also, surprisingly, results in microbiologically safe chilled-food compositions, even at elevated pH values. Moreover, the method of this invention does not adversely impact the taste, olfactory and visual characteristics of the food compositions comprising the above-described preservative system.

Additional Information

Efforts have been disclosed for making preservative systems. In International Publication WO 03/094638, preservative and protective systems derived from lauric acid and arginine are described.

Other efforts have been disclosed for making preservative systems. In International Publication WO 03/013454, preservative systems for cosmetic preparations are described.

Even other efforts have been disclosed for making microbiologically stable food compositions. In U.S. Pat. No. 6,036,986, cinnamic acid for use in tea-containing beverages is described.

None of the additional information above describes a method for using a mixture of saturated, unsaturated, and optionally, aromatic preservatives that are effective for use across a wide range of food compositions to render the same microbiologically stable and safe.

### SUMMARY OF THE INVENTION

In a first aspect, the present invention is directed to a method for preserving a food composition with a preservative system comprising:
(a) from about 0.75 to about 7.0 percent by weight of saturated preservative;
(b) from about 5.0 to about 99.25 percent by weight of unsaturated preservative; and
(c) optionally, from about 0.0 to about 94.25 percent by weight of an aromatic preservative

wherein the food composition is microbiologically safe and stable and all percents by weight are based on total weight of the preservative system.

In a second aspect, the present invention is directed to a food composition preserved via the method of the first aspect of this invention.

Food composition, as used herein, means a composition suitable for consumption by humans, including a filling, dip, sauce, spread, dressing, refrigerated salad, beverage or the like. Microbiologically stable (i.e., spoilage free) means no outgrowth of spoilage bacteria, yeast and/or mold and no flavor loss for at least about three (3) months, and preferably, for at least about ten (10) months before opening when kept at about 25° C. and at a pH of less than about 4.20. When chilled, microbiologically stable means no outgrowth of spoilage bacteria, yeast and/or mold and no flavor loss for at least about four (4) weeks, and preferably, for at least about six (6) weeks before opening when kept at about 5° C. and a pH of less than 6.0. Microbiologically safe (for products kept at about 25° C. and 5° C.) means preventing the outgrowth of pathogens and/or achieving and maintaining at least about a 2 log die off of pathogens (like Listeria momocytogenes) within a fourteen (14) day period (preferably seven (7) day period) when kept at a pH from about 3.0 to less than 5.0. Semi-soluble in water means 0.20 to about 0.30% soluble in water at about 30° C. In the absence of organic acids means at an amount that normally does not exert an antimicrobial effect (i.e., under about 0.40% by weight as an additive), and preferably, 0.0% by weight of added organic acid. Elevated pH is defined to mean greater than 4.20 but preferably less than 5.0, and most preferably, less than or equal to 4.80. Not sour, as used herein, is meant to mean having a taste substantially the same as a freshly made food composition and not more sour than the same. Aromatic preservative is defined to mean a preservative with at least one portion that has a ring with lower pi-electron energy than the open chain of the ring.

The only limitation with respect to the type of saturated preservative used in this invention is that the same is suitable for human consumption, and preferably, has a pKa of under about 5.0 and is water insoluble. Illustrative examples of the type of saturated preservatives suitable for use in this invention include those having the formula: 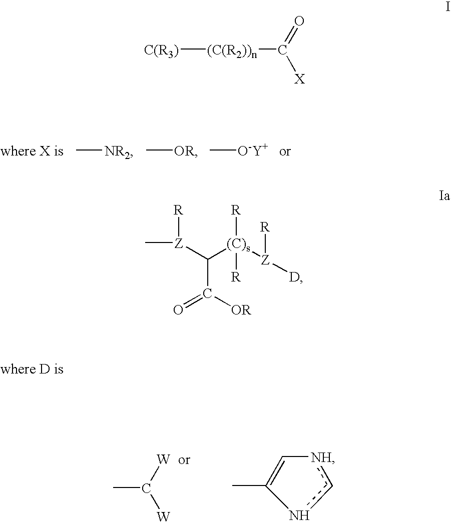
each W is independently —NR₂, each Y is independently a group IA element, each R is independently a C₁-C₄ alkyl or hydrogen, each Z is independently a heteroatom (preferably nitrogen), n is an integer from about 1 to about 12, and s is an integer from about 2 to about 6, with the proviso that when X is a structure represented by Ia, the saturated preservative is preferably a monohydrohalide. In a preferred embodiment, R is hydrogen, X is a structure represented by Ia, —OH or —O⁻Na⁺, and n is an integer from about 6 to about 12, and s is an integer from about 2 to about 4. In a most preferred embodiment, the saturated preservative is derived from lauric acid and arginine and is an ethyl ester of the lauramide of arginine monohydrochloride (LAE), whereby a more detailed description of the same may be found in U.S. Patent Application No. 2004/0265443 A1, the disclosure of which is incorporated herein by reference.

As to the unsaturated preservative, the same is limited only to the extent that it has at least one carbon-to-carbon bond having a bond order greater than one (1) and may be employed in food compositions suitable for human consumption, and preferably, has a pKa of under about 5.5, is semi-soluble in water, and/or is a functionalized alpha-beta compound. Illustrative examples of the types of unsaturated preservatives suitable for use in this invention include those classified as a polyene macrolide antibiotic and those having the formula: 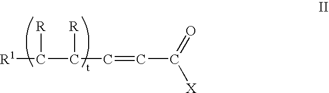
where 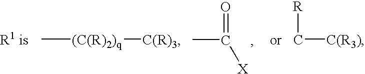
and R and X are as previously defined, q is 0 to about 12, and t is from 0 to about 6, with the proviso that when R¹ forms part of an sp² hybridized carbon-carbon bond, t does not equal zero. In a most preferred embodiment, the unsaturated preservative is a polyene macrolide antibiotic like natamycin (or pimaricin), a compound represented by II, like sorbic acid or a mixture thereof.

Regarding the optional (but often preferred) aromatic preservative, the same is limited only to the extent that it can be used in a human consumable food composition. Such an aromatic preservative preferably has a pKa of under about 5.0 and is water soluble.

Illustrative and non-limiting examples of the aromatic preservatives suitable for use in this invention include, benzoic acid, coumaric acid, salicylic acid, vanillic acid, caffeic acid, cinnamic acid, ferulic acid, salts thereof, derivatives thereof, mixtures thereof and the like.

The preservative system of this invention typically comprises from about 2.5 to about 25.0, and preferably, from about 2.5 to about 15.0, and most preferably, from about 2.5 to about 6.0 times by weight more unsaturated preservative than saturated preservative. The unsaturated preservative to aromatic preservative ratio, however, is often from about 25 to about 75, to about 75 to about 25, and preferably, from about 45 to about 55, to about 55 to about 45 when aromatic preservative is used.

The total weight of preservative system employed in the food composition of this invention is limited only to the extent that the resulting food composition is microbiologically stable and safe as defined herein. Typically, however, the food compositions made via the method of this invention have from about 0.002 to about 1.5, and preferably, from about 0.005 to about 0.4, and most preferably, from about 0.01 to about 0.30 percent by weight preservative system (as pure preservative), based on total weight of food composition and including all ranges subsumed therein.

When conducting the method of this invention, preservative system (or the desired components thereof) can be combined with ingredients to make a food composition or combined with a food composition having already been prepared whereby combined is meant to optionally include marinating. Surprisingly, and again, when conducting the method of this invention, a food composition, like a filling, dip, sauce, spread, dressing, beverage or the like, is rendered microbiologically safe and stable in the absence of organic acids and at elevated pH values.

The food compositions made via the method of this invention, unexpectedly, are not sour even when the same are formulated to have a pH below 4.20. Such food compositions can comprise meat, fish, crustaceans, poultry products, bread crumbs, vegetables (including chunks and puree), protein, wheat, sweeteners (including sugar and artificial sweeteners), oil, emulsions, fruit (including chunks and puree), cheese, nuts, mixtures thereof or the like.

Illustrative and no-limiting examples of preferred food compositions prepared via the method of this invention include pourable dressings, fruit based compositions and mayonnaise comprising salads like coleslaw, tuna, macaroni, and chicken salad.

Preferred food compositions can also comprise soluble fibers, insoluble fibers, gums, starches, cellulose, vitamins, chelators, buffers, antioxidants, colorants, acidulants (including inorganic acids), emulsifiers, alcohol, water, spices (including salt), syrups, milk, food grade dispersants or stabilizers (like propylene glycol alginate), solubilizing agents (like propylene glycol), milk powder or mixtures thereof.

The packaging suitable for use with the food compositions made according to this invention is often a glass jar, food grade sachet, a plastic tub or squeezable plastic bottle. Sachets are preferred for food service applications, a tub is preferred for spreads and a squeezable plastic bottle is often preferred for non-spreads and domestic use.

The following examples are provided to illustrate an understanding of the present invention. The examples are not intended to limit the scope of the claims.

### EXAMPLE 1

Avocado-based compositions having a fork-mashed texture were made by mixing the following ingredients:

TABLE 1

| | Weight Percent of Formula |
|---|---|
| A. Ingredient-Oil Phase | |
| Soybean oil | 18.6 |
| Polysorbate 60 | 0.3 |
| B. Ingredient-Fiber Phase | |
| Water | 43.1 |
| Sorbic Acid | 0.10 |
| Citrus fiber | 2.60 |
| Potato starch | 1.00 |
| Milk powder | 0.75 |
| Gums | 0.21 |
| Corn syrup | 11.13 |
| EDTA | 0.007 |
| Color | 0.075 |
| Sugar | 1.00 |
| Salt | 1.02 |
| C. Ingredient-Final Mix | |
| Fiber phase | 61.0 |
| Oil phase | 18.9 |
| Avocado flesh | 19.7 |
| Hydrochloric acid | 0.34 |
| Propylene glycol | 0.045 |
| LAE | 0.005 |
| Natamycin | 0.0004 |

Ingredients of the oil and fiber phases were combined and mixed under moderate shear at atmospheric pressure and ambient temperature in a conventional mixer to produce a coarse emulsion. The coarse emulsion was then subjected to a homogenizer (e.g., APV Gaulin Homogenizer) pressurized to about 250 bar. The resulting emulsion was combined with the ingredients in the final mix to produce an avocado-based composition. The same was then subjected to a votator for about three (3) minutes at 75° C. resulting in an avocado-based composition having a pH of about 3.5.

### EXAMPLE 2

Avocado-based compositions (pH ˜3.5) were made in a manner similar to the one described in Example 1 except that water was added in lieu of LAE and natamycin.

### EXAMPLE 3

Avocado-based compositions (pH ˜3.5) were made in a manner similar to the one described in Example 1 except that 0.0005% by weight of nisin was used in lieu of LAE.

TABLE I

| | APRYⁱ | LBLⁱⁱ | LBHⁱⁱⁱ |
|---|---|---|---|
| Example 1 | N | N | N |
| Example 2 | Y | N | Y |
| Example 3 | Y | N | N |

ⁱ= Acid preservative resistant yeast; initial inoculation about 100 cfu/g
ⁱⁱ= Lactobaccilli low; initial inoculation about 100 cfu/g
ⁱⁱⁱ= Lactobaccilli high; initial inoculation about 1000 cfu/g
N = no growth;
Y = growth

Table I shows the results of a stability/spoilage challenge study for the avocado-based compositions made in Examples 1-3. The avocado-based composition of Example 1 was made in a manner consistent with the invention described herein. Surprisingly, no outgrowth of spoilage yeast and bacteria was observed for at least 3 months at the identified inoculation levels. Example 2, an avocado-based composition with sorbic acid and no LAE and natamycin, shows the growth of yeast and bacteria within a three month period. Example 3, an avocado-based composition with sorbic acid, nisin and natamycin, shows yeast growth within three months notwithstanding the presence of natamycin as an antifungal agent. The results show that food compositions are unexpectedly microbiologically stable and safe when subjected to the method of this invention.

### EXAMPLE 4

A blue cheese dressing having a pH of about 3.8 was made by mixing the following ingredients:

| Ingredient | Weight Percent of Formula |
|---|---|
| Water | Balance |
| Soybean Oil | 43.0 |
| Vinegar (10%) | 6.01 |
| NaCl | 2.00 |
| Lactic acid (88%) | 0.372 |
| Flavor | 0.44 |
| Polysorbate 60 | 0.22 |
| Vitamin | 0.005 |
| Cheese crumbs | 12.0 |
| Sucrose | 1.96 |
| Dispersant | 0.174 |
| Potassium sorbate | 0.10 |
| Garlic Powder | 0.10 |
| EDTA | 0.007 |
| Gum | 0.70 |
| Propylene glycol | 0.045 |
| LAE | 0.005 |

### EXAMPLE 5

The blue cheese dressing of Example 5 was made in a manner similar to the one described in Example 4 except that water was added in lieu of LAE. A spoilage study was conducted on the blue cheese dressings of Examples 4 and 5. The dressing composition of Example 4, made in a manner consistent with this invention, showed no outgrowth of acid preservative resistant yeast and Lactobacilli at low and high initial inoculation levels (i.e., about 50 cfu/g and 5,000 cfu/g, respectively). The dressing composition of Example 5 displayed growth of spoilage yeast and Lactobacilli bacteria within one (1) week.

### EXAMPLE 6

Chicken salad compositions (pH ˜4.7) were made by combining the following ingredients:

| Ingredient | Weight Percent of formula |
|---|---|
| Water | Balance |
| LAE | 0.015 |
| Propylene glycol | 0.135 |
| Potassium sorbate | 0.100 |
| Sodium benzoate | 0.100 |
| Onion | 6.00 |
| Celery | 14.50 |
| Salt | 0.120 |
| Sugar | 2.20 |
| Black Pepper | 0.10 |
| Xanthan Gum | 0.20 |
| Bread Crumbs | 3.00 |
| Hellmann's Mayonnaise | 24.4 |
| Phosphoric acid | 0.79 |
| Chicken | 48.00 |

Storage studies of the same indicated no yeast or bacteria outgrowth for at least seven (7) weeks, even at temperatures of about 7° C. Safety studies also indicated at least a 2 log decline in pathogenic (Listeria monocytogenes) levels in about seven (7) days.

What is claimed is:

1. A method for making a food composition microbiologically stable and safe comprising the steps of:
(a) contacting a food composition or ingredients of a food composition with a saturated preservative, unsaturated preservative, and optionally, an aromatic preservative; and
(b) recovering the food composition
wherein the food composition displays no outgrowth of Lactobacilli, acid preservative resistant yeast and mold for at least about three (3) months before opening and when kept at a temperature of about 25° C. and at a pH of less than about 4.2, or for at least about (4) weeks before opening when kept at a pH of less than 6 at a temperature of 5° C., and prevents the outgrowth of pathogens, and achieves and/or maintains at least a 2 log decline of pathogens within a fourteen (14) day period when kept at a pH from about 3.0 to about less than 5.0.

2. The method of claim 1 wherein the food composition is a dip, sauce, spread, dressing, refrigerated salad or beverage.

3. The method of claim 1 wherein the saturated preservative has a pKa of under 5 and is water insoluble.

4. The method of claim 1 wherein the saturated preservative has the formula: 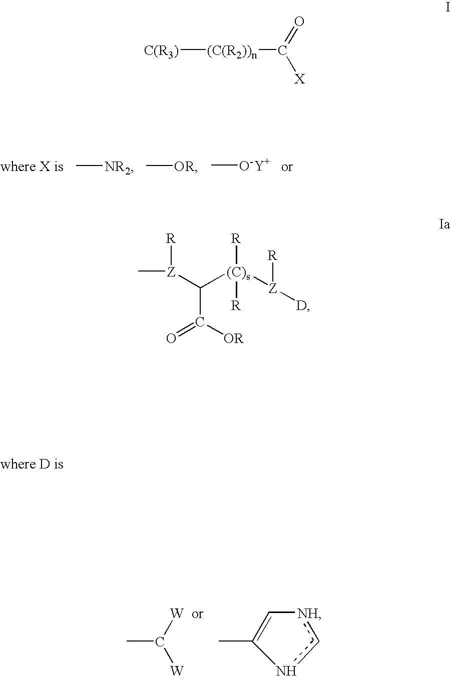
each W is independently —NR₂, each Y is independently a Group IA element, each R is independently a C₁-C₄ alkyl or hydrogen, each Z is independently a heteroatom, n is an integer from about 1 to about 12, and s is an integer from about 2 to about 6.

5. The method of claim 4 wherein R is hydrogen, X is a structure represented by —OH or —O—Na⁺, and n is an integer from about 6 to about 12 and s is an integer from about 2 to about 4.

6. The method of claim 1 wherein the saturated preservative is LAE.

7. The method of claim 1 wherein the unsaturated preservative has a pKa of under about 5.5, is semi-soluble in water and/or is a functionalized alpha-beta compound.

8. The method of claim 1 wherein the unsaturated preservative is a polyene macrolide antibiotic or a compound having the formula: 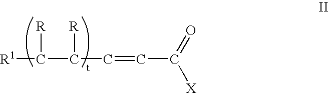
where 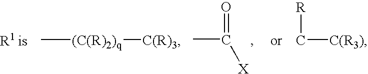
and R and X are as previously defined, q is 0 to about 12, and t is from 0 to about 6, with the proviso that when R¹ forms part of an sp² hybridized carbon-carbon bond, t does not equal zero.

9. The method of claim 7 wherein the unsaturated preservative is pimaricin, sorbic acid or a mixture thereof.

10. The method of claim 1 wherein the aromatic preservative has a pKa of under about 5.0 and is water soluble.

11. The method of claim 1 wherein the aromatic preservative is benzoic acid, coumaric acid, salicylic acid, vanillic acid, caffeic acid, cinnamic acid, ferulic acid, salts thereof, derivatives thereof or a mixture thereof.

12. The method of claim 1 wherein about 2.5 to about 25 times more unsaturated preservative is present than saturated preservative.

13. The method of claim 1 wherein the aromatic preservative is present and the unsaturated preservative and aromatic preservative are at a ratio from about 25 to about 75 to about 75 to about 25.

14. The method of claim 1 wherein preservative makes up from about 0.002 to about 1.5 percent by weight of the food composition.

15. The method of claim 1 wherein the food composition or ingredients of the food composition are marinated with saturated preservative, unsaturated preservative, and optionally, aromatic preservative.

16. The method of claim 1 wherein preservative makes up from about 0.005 to about 0.4 percent by weight of the food composition.

17. A food composition made by the method of claim 1.

18. The food composition according to claim 17 wherein the food composition is a filling, dip, sauce, spread, dressing, refrigerated salad or beverage.
